(19) United States
(12) Patent Application Publication
(10) Pub. No.: US 2025/0238920 A1
(43) Pub. Date: Jul. 24, 2025

(54) INSPECTION SYSTEM, INSPECTION APPARATUS, METHOD OF CONTROLLING THE INSPECTION APPARATUS, AND STORAGE MEDIUM

(71) Applicant: CANON KABUSHIKI KAISHA, Tokyo (JP)

(72) Inventor: YUKICHIKA ICHIHASHI, Chiba (JP)

(21) Appl. No.: 19/033,900

(22) Filed: Jan. 22, 2025

(30) Foreign Application Priority Data
Jan. 23, 2024 (JP) 2024-008221

(51) Int. Cl. G06T 7/00

(52) U.S. Cl. CPC G06T 7/001; G06T 2207/30144

(57) ABSTRACT

An inspection apparatus reads a print product formed by an image forming device to obtain an inspection target image, obtains a reference image to be used in an inspection of the inspection target image, determines an inspection area to be targeted in an inspection in the reference image in accordance with whether or not an unnecessary part removal process for removing an unnecessary part of the print product is executed, and, based on the inspection area, performs the inspection by comparing the reference image and the inspection target image. When determining the inspection area, the inspection apparatus determines an area remaining after removing a part corresponding to the unnecessary part from the reference image to be the inspection area in a case of that the unnecessary part removal process is executed.

### BACKGROUND OF THE INVENTION

### Field of the Invention

The present invention relates to an inspection system, an inspection apparatus, a method for controlling the inspection apparatus, and a storage medium.

### Description of the Related Art

There is a demand for digital printers to achieve the high quality of offset printing machines and efficiently produce print products. In order to achieve both a guarantee of print quality and print product productivity, in recent years, inspection apparatuses for performing quality inspection of print products on a conveyance path after printing have been proposed.

In book form printing and the like, a trim mark indicating a cutting position is printed on a printed image when printing on a large-sized recording sheet. In a subsequent step of the printing apparatus, a sheet cutting device performs cutting based on the cutting position specified by the trim mark. That is, the inside of the trim mark in the print product is the area of the product to be delivered, and the area outside trim mark is the area to be cut and discarded.

Meanwhile, in seal/label printing in which printing is performed on a sheet in which a carrier and an adhesive paper overlap each other, cutting using a trim mark is not executed. An automated cutting device uses Computer Aided Design (CAD) data to remove only the adhesive paper other than a seal part, leaving only the seal part used as a product on the carrier. The process of removing adhesive paper other than the seal part and leaving only the seal part on carrier is called an unnecessary part removal process. Whether or not to perform the unnecessary part removal process is optional, and the product may be delivered with the adhesive paper other than the seal part still attached to the carrier, without performing the unnecessary part removal process.

Japanese Patent Laid-Open No. 2007-50546 describes a printing apparatus in which, as a method in which an unnecessary inspection of a medium which is to be discarded by a cutting process is not performed, in a case where the cutting process is to be executed in a subsequent step, the outside of a trim mark is determined as a cutting area, and only the inside of trim mark is inspected.

However, with the technique of Japanese Patent Laid-Open No. 2007-50546, in seal/label printing where a trim mark is not printed, since the cutting position cannot be specified, a disposal part to be a discarded also ends up being inspected. Therefore, even in a case where a non-discarded image part of the print product is normal, the inspection will fail if dust or dirt adheres to the disposal part or the like. For this reason, print products that would otherwise pass the inspection if the disposal part had been removed will end up being determined to fail the inspection. Therefore, in seal/label printing, there is a demand for a disposal part which is to be discarded by the unnecessary part removal process to be removed from the inspection target to thereby not execute an unnecessary inspection.

### SUMMARY OF THE INVENTION

Embodiments of the present disclosure eliminate the above-mentioned issues with conventional technology.

A feature of embodiments of the present disclosure is to provide a technique for, in a case of a process for removing an unnecessary part of a print product, eliminating a useless inspection process by excluding the unnecessary part from an inspection target, and reducing a possibility that a print product that should pass an inspection will end up failing the inspection.

According to embodiments of the present disclosure, there is provided an inspection apparatus, comprising: one or more controllers including one or more processors and one or more memories, the one or more controllers configured to: read a print product formed by an image forming device to obtain an inspection target image; obtain a reference image to be used in an inspection of the inspection target image; determine an inspection area to be targeted in an inspection in the reference image in accordance with whether or not an unnecessary part removal process for removing an unnecessary part of the print product is executed; and based on the inspection area, perform the inspection by comparing the reference image and the inspection target image, wherein in determining the inspection area, the one or more controllers determine an area remaining after removing a part corresponding to the unnecessary part from the reference image to be the inspection area in a case of that the unnecessary part removal process is executed.

According to embodiments of the present disclosure, there is provided an inspection system, comprising: an inspection apparatus comprising one or more controllers including one or more processors and one or more memories, the one or more controllers configured to: read a print product formed by an image forming device to obtain an inspection target image; obtain a reference image to be used in an inspection of the inspection target image; determine an inspection area to be targeted in an inspection in the reference image in accordance with whether or not an unnecessary part removal process for removing an unnecessary part of the print product is executed; and based on the inspection area, perform the inspection by comparing the reference image and the inspection target image, wherein in determining the inspection area, the one or more controllers determine an area remaining after removing a part corresponding to the unnecessary part from the reference image to be the inspection area in a case of the unnecessary part removal process is executed, and an image forming device generates a print product in which an image is printed on a recording medium, wherein the inspection apparatus inspects the print product generated by the image forming device.

According to embodiments of the present disclosure, there is provided a method for controlling an inspection apparatus, the method comprising: reading a print product formed by an image forming device to obtain an inspection target image; obtaining a reference image to be used in an inspection of the inspection target image; determining an inspection area to be targeted in an inspection in the reference image in accordance with whether or not an unnecessary part removal process for removing an unnecessary part of the print product is executed; and based on the determined inspection area, performing the inspection by comparing the reference image and the inspection target image, wherein in determining the inspection area, the one or more controllers determine an area remaining after removing a part corresponding to the unnecessary part from the reference image to be the inspection area in a case that the unnecessary part removal process is executed.

Further features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is an overall configuration diagram of an image inspection system according to an embodiment of the present invention.

FIG. 2 is a block diagram for describing a hardware configuration of each device included in the image inspection system according to the embodiment.

FIGS. 3A to 3C are functional block diagrams for respectively describing processing according to programs stored in a recording unit of an inspection apparatus, a recording unit of a printing apparatus, and a recording unit of a PC according to the embodiment.

FIG. 4 is a sequence diagram for describing a flow of processing in the image inspection system according to a first embodiment.

FIG. 5A depicts a view illustrating an example of a print setting screen displayed on an operation unit of a PC according to the first embodiment.

FIGS. 5B to 5D depict views respectively illustrating examples of screens for when a print sample image displayed on the operation unit of the inspection apparatus is registered.

FIGS. 5E and 5F depict views respectively illustrating examples of screens that are displayed on the operation unit of the inspection apparatus and that indicate inspection results.

FIG. 6 is a flowchart for describing a process for registering an inspection area that is executed by the inspection apparatus according to the first embodiment.

FIGS. 7A to 7C depict views illustrating a process for determining an inspection area based on cutting data according to the first embodiment.

FIGS. 7D to 7F depict views illustrating a process for determining an inspection area based on image data.

FIG. 7G depicts a view illustrating a division of areas of a sample image in a second embodiment.

FIG. 8 is a flowchart for explaining a process for registering an inspection area based on image data of step S604 of FIG. 6.

FIG. 9 is a sequence diagram illustrating a flow of processing in the image inspection system according to the second embodiment.

FIG. 10 is a flowchart for describing a process for registering an inspection area of step S902 of FIG. 9 according to the second embodiment.

FIG. 11 is a flowchart for explaining a process for determining an inspection area based on image data of step S1004 of FIG. 10.

### DESCRIPTION OF THE EMBODIMENTS

Embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted.

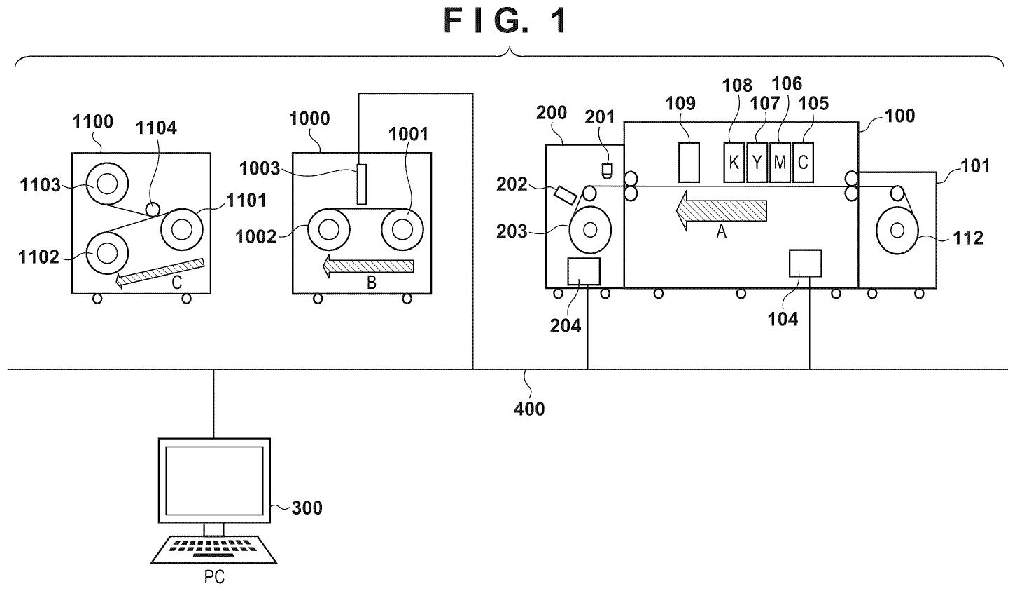

FIG. 1 is an overall configuration diagram of an image inspection system (a print product inspection system) according to an embodiment of the present invention. In the following explanation, a printing apparatus 100 may also be referred to as an image forming device, a printer, a multifunction device, a multifunction peripheral, or a Multi Function Peripheral (MFP).

A personal computer (PC) 300 is connected to the printing apparatus 100 via a LAN 400. Further, an inspection apparatus 200 is connected to the LAN 400. The printing apparatus 100 and the inspection apparatus 200 are connected to each other so that a print product (media) printed by the printing apparatus 100 can be directly conveyed therebetween. The printing apparatus 100 and the inspection apparatus 200 may be collectively referred to as a print inspection apparatus.

The printing apparatus 100 is connected to a sheet feeding unit 101. A control unit 104 controls the printing apparatus 100. The control unit 104 can be controlled to connect the printing apparatus 100 to the LAN 400. The sheet feeding unit 101 is capable of loading roll paper used for seal/label printing, and the roll paper is installed in a roll paper winding unit 112. Roll paper is one type of recording medium in the present invention, but the present invention can be applied to various forms of media, such as a continuous form sheet, cut paper, or the like. Further, the present invention can be applied to various printable materials such as cloth, plastic material, and metal material.

A recording medium fed from the sheet feeding unit 101 is conveyed in the direction indicated by arrow A. In the conveyance path, ink or toner of a color corresponding to each unit is transferred to the recording medium from a cyan station 105, a magenta station 106, a yellow station 107, and a black station 108, which are image forming units, and an image is thereby formed. In embodiments, the method for forming an image on a recording medium is not particularly limited, and an electrophotographic method, an offset method, an ink jet method, or the like may be considered. A fixing unit 109 is a device that fixes a coloring material such as toner/ink to a recording medium. The fixing unit 109 may differ depending on the image forming method, and for example, with an electrophotographic method, a thermocompression bonding method can be considered, and with an inkjet method, a drying method and the like can be considered.

Subsequent to the fixing unit 109, a reading sensor 201 of the inspection apparatus 200 is arranged. The reading sensor 201 reads an image formed on the recording medium to obtain scanned image data. The reading sensor 201 is, for example, an image reading sensor using an element such as a Complementary Metal Oxide Semiconductor (CMOS) sensor, a Charge Coupled Device (CCD), or the like. The reading sensor 201 may be a line sensor or an area sensor having a length in a main scanning direction of the recording medium. The reading sensor 201 converts an image of the entire conveyed recording medium to a high resolution, e.g., 300 dpi (dots/inch) image data.

The inspection apparatus 200 includes a mark affixing device 202, a sheet winding device 203, and a control unit 204. The mark affixing device 202 may affix a mark anywhere on the recording medium. This is used to affix a mark at a predetermined position on a recording medium that the inspection device has determined fails the inspection.

As described above, the personal computer (PC) 300 is connected to the printing apparatus 100 via the LAN 400. The PC 300 is used to perform printing in the printing apparatus 100. Note that, although the embodiment is described using the PC 300, this device need not be a PC, and may be implemented as any device that realizes a process for performing printing or a device that executes a program having such a function.

A sheet cutting device 1000 is a device that performs half-cutting of a recording medium such as a seal/label printed by the printing apparatus 100 in accordance with shape data (cut data), such as CAD data, recorded according to an electronic method. The sheet cutting device 1000 leaves a carrier of the seal/label and only adds a cut to the seal/label part in the seal/label shape. Inside the sheet cutting device 1000, roll paper winding units 1001 and 1002 are mounted and convey the recording medium in the direction of arrow B. A recording medium is half-cut directly under a cutter 1003 during conveyance according to a CAD data shape. As described above, since the sheet cutting device 1000 and the personal computer (PC) 300 are connected via the LAN 400, the PC 300 can transfer the CAD data to the sheet cutting device 1000.

A peeling device 1100 performs a so-called unnecessary part removal process in which unwanted adhesive paper other than the label of recording medium for a seal/label or the like that is half-cut by the sheet cutting device 1000, is wound up and removed. Inside the peeling device 1100, roll paper winding units 1101, 1102, and 1103 are mounted and convey the recording medium in the direction of arrow C after the unnecessary part removal process has been performed thereon. The roll paper winding unit 1103 is a winding unit that winds unwanted adhesive paper separated by a separation device 1104 in the unnecessary part removal process. In addition, the roll paper winding unit 1102 is a unit that winds a recording medium including a seal, a label, or the like from which unwanted adhesive paper has been removed. Although the peeling device 1100 is not connected to the network 400 in the embodiment, the present invention is not limited thereto. For example, the peeling device 1100 may be connected to the network 400 to perform control and data sharing with the PC 300.

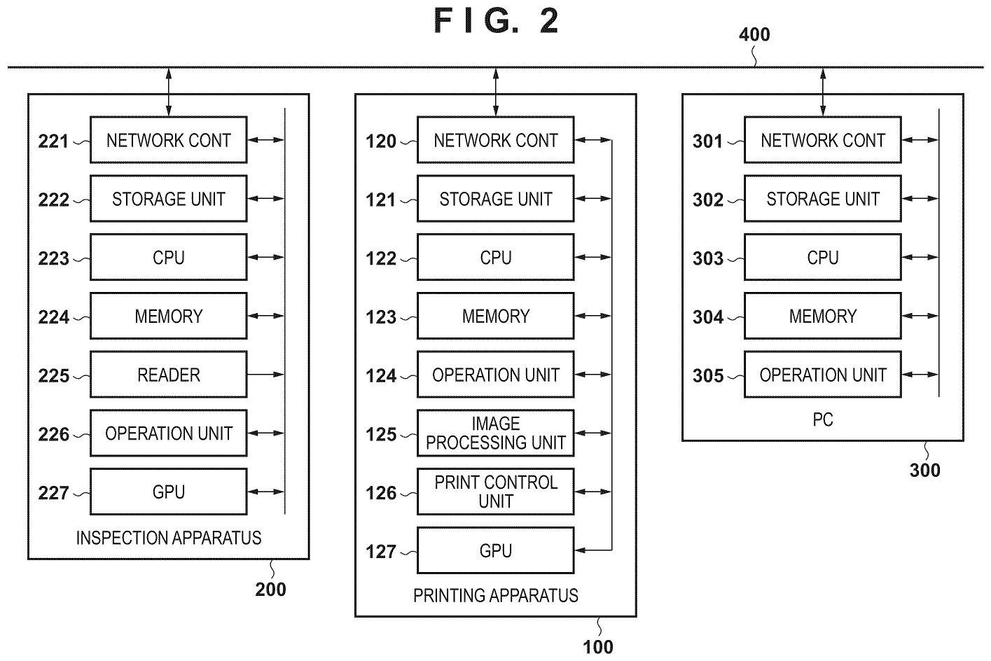

FIG. 2 is a block diagram for describing a hardware configuration of each device included in the image inspection system according to the embodiment.

The printing apparatus 100 is connected to the LAN 400 via a network controller 120. Processes executed by the printing apparatus 100 are realized by deploying a program stored in a storage unit 121 into a memory 123 and a CPU 122 executing the deployed program. The storage unit 121, the CPU 122 and the memory 123 correspond to the control unit 104 of FIG. 1. The printing apparatus 100 has an operation unit 124, and can display on a screen of the operation unit 124 in order to receive an input operation. An image processing unit 125 converts electronic image data (e.g., CIE-sRGB multi-valued image data) into electronic image data for printing (e.g., a CMYK halftone image). Further, the electronic image data for printing is transferred to a print control unit 126, and an image is printed onto a recording sheet fed from the sheet feeding unit 101 using the image forming stations 105 to 108 of FIG. 1. A GPU 127 cooperates with the CPU 122 to control operation of the printing apparatus 100.

The inspection apparatus 200 is connected to the LAN 400 via a network controller 221. Processes executed by the inspection apparatus 200 are realized by deploying a program stored in a storage unit 222 into a memory 224 and a CPU 223 executing the deployed program. The CPU 223 also converts an image of a recording medium into electronic image data (e.g., RGB multi-valued image data) using a reader 225 connected to the reading sensor 201. The storage unit 222, the CPU 223, and the memory 224 correspond to the control unit 204 of FIG. 1. An operation unit 226 also functions as a display unit that displays an inspection setting screen, which will be described later, and also receives input from a user. The display unit may have a touch panel function. Further, the CPU 223 controls a screen to be displayed on the display unit of the operation unit 226, and in the embodiments, the CPU 223 may be referred to as a display control unit. Further, since a GPU 227 is mounted, inspection times can be made shorter than printing times per page by accelerating the inspection process thereby. In the embodiment, it is described that the inspection apparatus 200, which is connected to a subsequent stage of the printing apparatus 100, performs the inspection process, but the present invention is not limited thereto. For example, an inspection PC that specializes in inspection processing may be connected via a communication unit to an inspection device that mainly performs image capturing, and the inspection PC, after receiving an image captured by the inspection device, may execute an inspection process based on inspection settings that it has received.

The PC 300 is connected to the LAN 400 via a network controller 301, which makes an instruction for printing to the printing apparatus 100. Processes executed by the PC 300 are realized by a CPU 303 deploying a program stored in a storage unit 302 into a memory 304 and the CPU 303 executing the deployed program. In addition, an operation unit 305 may include a display (not illustrated) and can display screens thereon. Further, a pointing device or a keyboard (not illustrated) can be connected to receive a user operation.

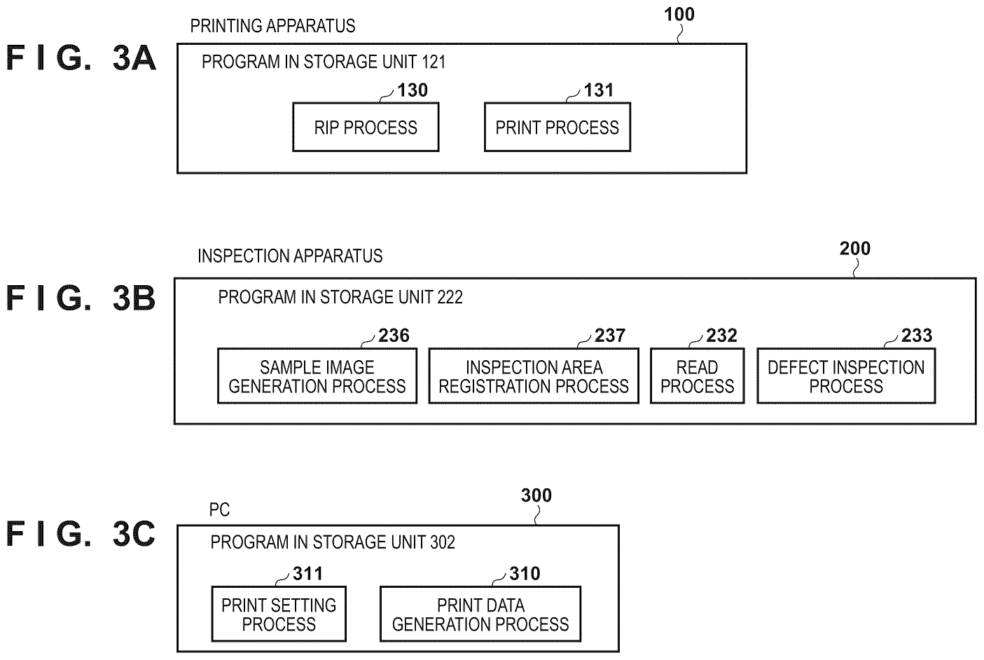

FIGS. 3A to 3C are functional block diagrams for respectively describing processes according to programs stored in the storage unit 222 of the inspection apparatus 200, the storage unit 121 of the printing apparatus 100, and the storage unit 302 of the PC 300 according to the embodiment.

FIG. 3A is a functional block diagram for describing processes executed by a program stored in the storage unit 121 of the printing apparatus 100. FIG. 3B is a functional block diagram for describing processes executed by a program stored in the storage unit 222 of the inspection apparatus 200. FIG. 3C is a functional block diagram for describing processes executed by a program stored in the storage unit 302 of the PC 300. The processes of each of the programs illustrated in FIGS. 3A to 3C will be described in detail below.

As described above, the printing apparatus 100, the inspection apparatus 200, and the PC 300 include the operation unit 124, the operation unit 226, and the operation unit 305, respectively. Further, it is assumed that the CPU 122 of the printing apparatus 100, the CPU 223 of the inspection apparatus 200, and the CPU 303 of the PC 300 have a function for executing a program to generate Hyper Text Markup Language (HTML) for display on respective screens. Thus, Hyper Text Transfer Protocol (HTTP) can be used for display to each of the operation units and for operations. Therefore, in the present embodiment, the devices for displaying and for receiving operations, and the display are not limited.

### First Embodiment

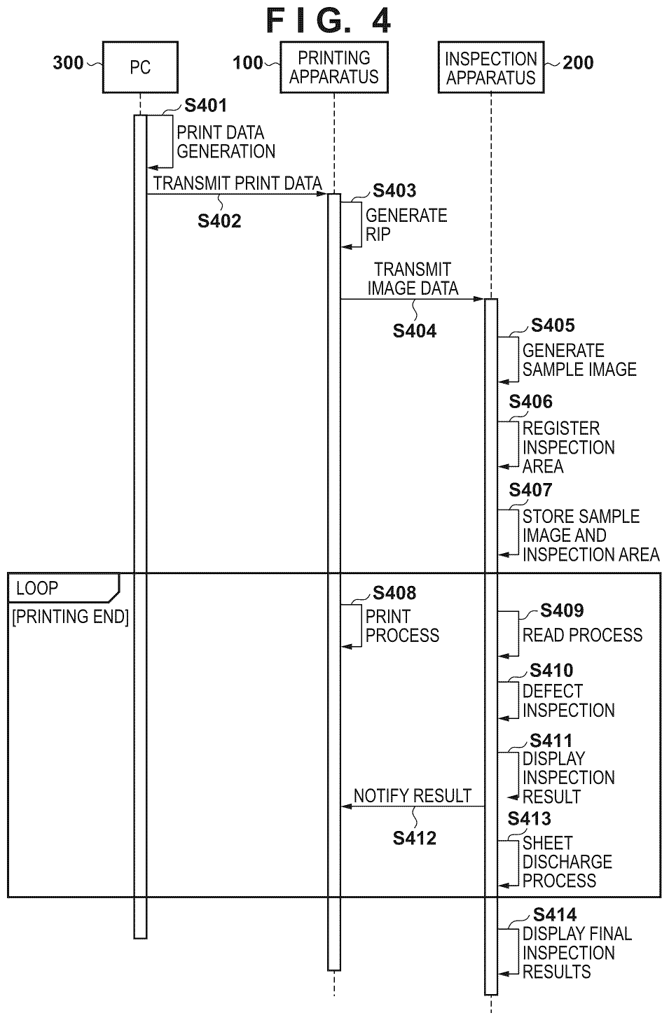

FIG. 4 is a sequence diagram for describing a flow of processing in the image inspection system according to the first embodiment. Hereinafter, printing and inspection processing will be described with reference to this sequence diagram.

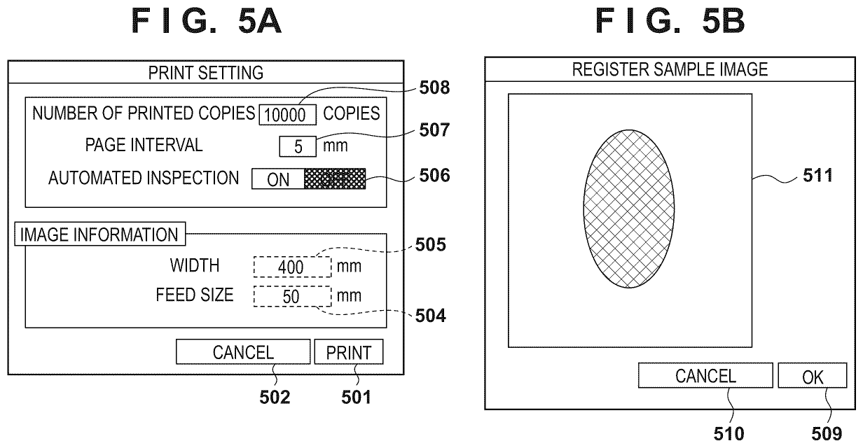

In step S401, upon receipt of a print command from the operation unit 305, the CPU 303 of the PC 300 executes a print data generation process 310 of FIG. 3C to generate print data. At this time, the print data generation process 310 displays a print setting screen illustrated in FIG. 5A on the operation unit 305 of the PC 300.

FIG. 5A depicts a view illustrating an example of a print setting screen displayed on the operation unit 305 of the PC 300, and FIGS. 5B to 5D depict views illustrating examples of screens for when a print sample image displayed on the operation unit 226 of the inspection apparatus 200 is registered. FIGS. 5E and 5F depict views illustrating examples of screens that are displayed on the operation unit 226 of the inspection apparatus 200 and that indicate inspection results.

In the example of the screen of FIG. 5A, a width 505 of the image to be printed, a size 504 in the feeding direction, a number of copies 508, a page interval 507, and an automated inspection on/off setting 506 can be set. The print instruction includes information inputted on the screen of FIG. 5A. In the first embodiment, assume that the automated inspection on/off setting 506 is set to on at all times. The print data generated here is composed of an image such as a JPEG or a TIFF, text data, and font information used for the text data, graphics rendering data, and the like. In addition, cutting data (cutting information) for performing half cutting in the sheet cutting device 1000 may be included in the print data. The print data is often generated in Portable Document Format (PDF), but the present invention is not limited to this, and print data using an original format may be adopted. A cancel button 502 is a button for canceling all the settings on this screen and returning to an original screen. A print button 501 is a button for making an instruction to perform printing in accordance with the content set on the setting screen. Print setting process using the print setting screen of FIG. 5A corresponds to a print setting process 311 of FIG. 3C.

Next, in step S402, the CPU 303 of the PC 300 transmits the print data generated in step S401 to the printing apparatus 100 through the LAN 400 based on the instruction on the print button 501.

In step S403, the CPU 122 of the printing apparatus 100 executes a RIP process 130 in FIG. 3A, and performs RIP processing for deploying the received print data as raster image data to generate image data. Here, “RIP process” means Raster Image Processor process, which is a process of generating image data from received print data. Specifically, PDL language including text and the image data is interpreted and converted into raster image data. The image data to be generated here is image data composed of CMYK color information or the like. At this time, if cutting data is included in the print data, the RIP process 130 generates a raster image in which the cutting area is specified by a line. In step S404, the CPU 122 of the printing apparatus 100 transmits the image data (raster image data) generated in step S403 to the inspection apparatus 200 via the LAN 400.

In step S405, the CPU 223 of the inspection apparatus 200 executes a sample image generation process 236 of FIG. 3B. Specifically, based on the image data received in step S404, a print sample image (reference image) for image inspection is generated and displayed on the operation unit 226. For example, if the image data is a CMYK image, a print sample image is generated by converting the image data into RGB image data by a color conversion process using an ICC profile stored in advance in the storage unit 222.

FIG. 5B depicts a view illustrating an example of an approval screen of a print sample image (reference image) displayed on the operation unit 226 of the inspection apparatus 200.

An image display area 511 is a display area for the operator to visually confirm the print sample image. As a result, the operator can visually confirm the print sample image displayed in the image display area 511. When the operator makes an instruction on an OK button 509 via the operation unit 226 when the displayed print sample image is satisfactory, the CPU 223 advances the processing to step S406. On the other hand, when the operator is not satisfied with the displayed print sample image, the operator makes and instruction on a cancel button 510 on the operation unit 226. In this case, all processes are stopped, and the process for generating the print sample image is ended.

In step S406, the CPU 223 of the inspection apparatus 200 executes an inspection area registration process 237 of FIG. 3B. FIGS. 5C and 5D illustrate screens of the inspection area registration process.

FIG. 5C depicts a view illustrating an example of a screen in a case where when the unnecessary part removal process is not executed in a subsequent step, and the entire surface of a page is inspected. On the other hand, FIG. 5D is an example of a screen in a case where the unnecessary part removal process is executed in a subsequent step, and only a design part on the recording medium is inspected.

In FIG. 5C, a checkbox 517 for “remove unnecessary parts” is not checked because the unnecessary part removal process is not executed, and a cutting data reference button 514 is not used. A display area 518 is an area for displaying the entire print sample image. Meanwhile, in FIG. 5D, the checkbox 517 of “remove unnecessary parts” is checked because the unnecessary part removal process is executed. Further, a cutting data file (File://xxx) is selected, by using the cutting data reference button 514, and displayed. The details of this processing and the illustrated screens will be described later.

Next, in step S407, the CPU 223 of the inspection apparatus 200 stores the sample image and inspection area settings generated in step S405 and step S406 in the storage unit 222. By the processes of step S401 to step S407 described above, the sample image and the inspection area are stored in the inspection apparatus 200 of the first embodiment.

Next, an inspection process according to the first embodiment will be described.

In step S408, the CPU 122 of the printing apparatus 100 executes a print process 131 of FIG. 3A. In the print process 131, the RIP image generated in the recording area in step S403 is read out, and the print process 131 is executed. In the print process 131, the image processing unit 125 is used to execute halftoning and the like of a four-color RIP image (CMYK), and then the image is transferred to the recording medium by each of the stations 105 to 108 in accordance with the signal value corresponding to each of CMYK image data. The image thus transferred is fixed to the recording medium by the fixing unit 109 and then conveyed directly under the reading sensor 201 of the inspection apparatus 200.

Then, in step S409, the CPU 223 of the inspection apparatus 200 executes a read process 232 in FIG. 3B, and obtains the size of one page in a feeding direction of recording medium printed in step S408 by reading it using the reading sensor 201. Then, the obtained image is stored in the memory 224 as an inspection target image.

Next, in step S410, the CPU 223 of the inspection apparatus 200 executes a defect inspection process 233 of FIG. 3B. In the defect inspection process 233, the sample image 511 of FIG. 5B obtained in step S407 and the inspection target image obtained in step S409 are limited to the inside of the inspection area determined in step S406 and compared, and if there is a difference, it is determined as a defect. Specifically, feature points are extracted from each of the sample image (reference image) and the inspection target image, and the sample image and the inspection target image are aligned based on the extracted feature points. If the difference between the pixel value (luminance value) of an inspection target pixel in the inspection target image subjected to the alignment and the pixel value (luminance value) of a comparison target pixel in the sample image is less than or equal to a threshold value, the defect inspection process 233 determines that the inspection target pixel is acceptable. Note that this threshold value is different for each inspection level for determining the strictness of the inspection.

When the inspection of all of the pixels is completed in this way, it is determined whether or not the inspection target image is normal based on whether or not a total of the pixels determined to be rejected is less than or equal to an acceptance threshold value. If the total number of pixels determined to be rejected is less than or equal to the acceptance threshold value, the defect inspection process 233 determines that the inspection target image is normal. Meanwhile, if the total number of pixels determined to be rejected exceeds the acceptance threshold value, the defect inspection process 233 determines that the inspection target image is not normal (that the inspection failed). Then, in step S411, the CPU 223 of the inspection apparatus 200 displays the inspection result of the inspection target image being inspected in the operation unit 226.

FIG. 5E depicts a view illustrating an example of a screen for displaying the inspection result.

In a display area 522, the inspection target image being inspected is displayed, and a defect 520 found in the inspection of step S410 is composited and displayed so as to be conspicuous. A stop button 525 is included in this screen, and when a press of the stop button 525 is received, the CPU 223 of the inspection apparatus 200 sends an emergency stop command to the CPU 122 of the printing apparatus 100. When the CPU 122 of the printing apparatus 100 receives the emergency stop command, it can issue a command to the print control unit 126 to cause printing to stop.

Then, in step S412, the CPU 223 of the inspection apparatus 200 notifies the printing apparatus 100 of test results for one page in the feeding direction. For example, when a predetermined number or more of defect locations are found, a defect is more likely to be occurring in the image forming stations 105 to 108. In order to make such a determination, it is necessary to transmit the inspection results from the inspection apparatus 200 to the printing apparatus 100 at all times to thereby share the inspection results.

In step S413, the CPU 223 of the inspection apparatus 200 performs a sheet discharge process. At this time, a mark may be affixed at a location determined to be a defect in examination of step S410, for example, at the position of the defect 520 in FIG. 5E, by the mark affixing device 202. In this way, the CPU 223 of the inspection apparatus 200 executes the processes of step S409 to step S413 for the number of printed sheets. Then, finally, in step S414, the CPU 223 of the inspection apparatus 200 displays the final inspection results on the operation unit 226.

FIG. 5F depicts a view illustrating an example of a screen for final inspection results. A number of defects 521 on all the print pages, a defect location list 519, and an image 523 of the inspection target image in which the defect was found are arranged. When the operator finishes checking this screen, the operator presses an OK button 524. In the example of FIG. 5F, the number of defects 521 indicates that a defect is detected in five out of 10000 print products. An example of “defect 1” selected in a defect location list 519 is displayed for the image 523 of the inspection target image.

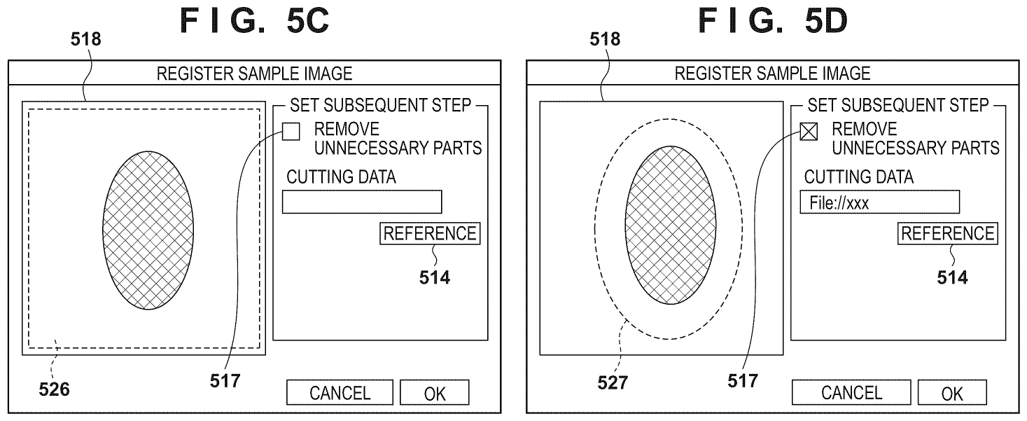

Next, the inspection area registration process 237 executed by the CPU 223 of the inspection apparatus 200 in step S406 will be described with reference to the example screens of FIGS. 5C and 5D and the flowchart of FIG. 6.

FIG. 6 is a flowchart for explaining a process for registering an inspection area executed by the inspection apparatus 200 according to the first embodiment. The process illustrated in this flowchart is achieved by the CPU 223 of the inspection apparatus 200 executing a program deployed to the memory 224.

In step S601, the CPU 223 determines whether or not to execute removal of unnecessary parts (the unnecessary part removal). For example, in a case that the CPU 223 receives that the checkbox 517 in FIG. 5C is checked, the CPU 223 determines that unnecessary part removal, in which unnecessary parts are removed, is to be executed, and the processing advances to step S602. If the checkbox 517 is unchecked, the processing advances to step S605. In a case that the presence/absence information of the peeling device 1100 is included in the print data to be generated in step S401 and the presence/absence information indicates that the peeling device 1100 is connected (the peeling device 1100 is present), the checkbox 517 may be checked as shown in FIG. 5D as the default.

In step S602, the CPU 223 determines whether the cutting data exists in the storage unit 222 or the memory 224. There are cases where the cutting data is simultaneously transferred as meta information of the image data received in step S404. If there is no cutting data in the meta information, in response to a press of the reference button 514, the cutting data may be obtained from CAD data stored in the storage unit 302 of the PC 300 or from an external recording unit (not illustrated). In this way, in a case that it is possible to obtain the cutting data in some way in step S602, the processing advances to step S603. On the other hand, in a case where the cutting data has not been obtained, the processing advances to step S604. In step S604, the CPU 223 determines the inspection area based on the image data. This process will be described in detail later. In step S603, the CPU 223 determines the inspection area using the cutting data.

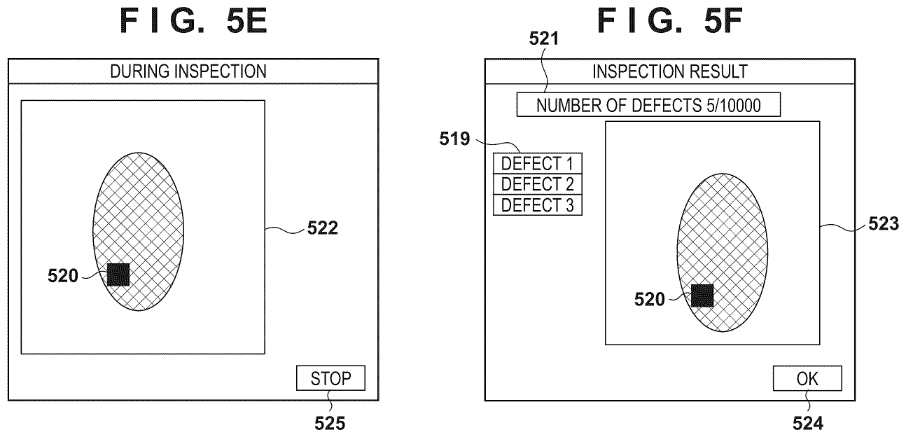

FIGS. 7A to 7C depict views for describing a process for determining an inspection area based on cutting data, and FIGS. 7D to 7F depict views for describing a process for determining an inspection area based on image data.

FIG. 7A depicts a view illustrating an example of cutting data.

The sheet cutting device 1000 performs a half cut along a cutting line 701. However, considering the registration accuracy of the sheet cutting device 1000 and the registration accuracy of the printing apparatus 100, an inspection needs to be performed in a region that extends outside of the actual cutting line. Therefore, as illustrated in FIG. 7B, the area needs to be widened in the outward direction (arrow directions) from the cutting line 701, and an inspection boundary line 702 indicating an enlarged area that is enlarged by a 10% enlargement process with reference to the center of the area surrounded by the cutting line 701, for example, is set. In regard to this predetermined enlargement amount of 10%, a value based on an aspect such as registration accuracy or the like may be set, and the present invention is not particularly limited thereto. The outside of the inspection boundary line 702 is a non-inspection area 704 which is not an inspection target, and the inside of the inspection boundary line 702 is an inspection area 705. Finally, the image of FIG. 7C, obtained by combining image data 703 and image data inside of the inspection boundary line 702, is displayed in the display area 518 of FIG. 5D. A boundary line 527 of FIG. 5D corresponds to the inspection boundary line 702 of FIG. 7C.

In step S605, the CPU 223 determines that unnecessary part removal is not performed, and the entire surface of the page is inspected. In this case, an inspection is executed in an inspection range 526 displayed in the display area 518 in FIG. 5C, and all of the printed surface is set to be inspected.

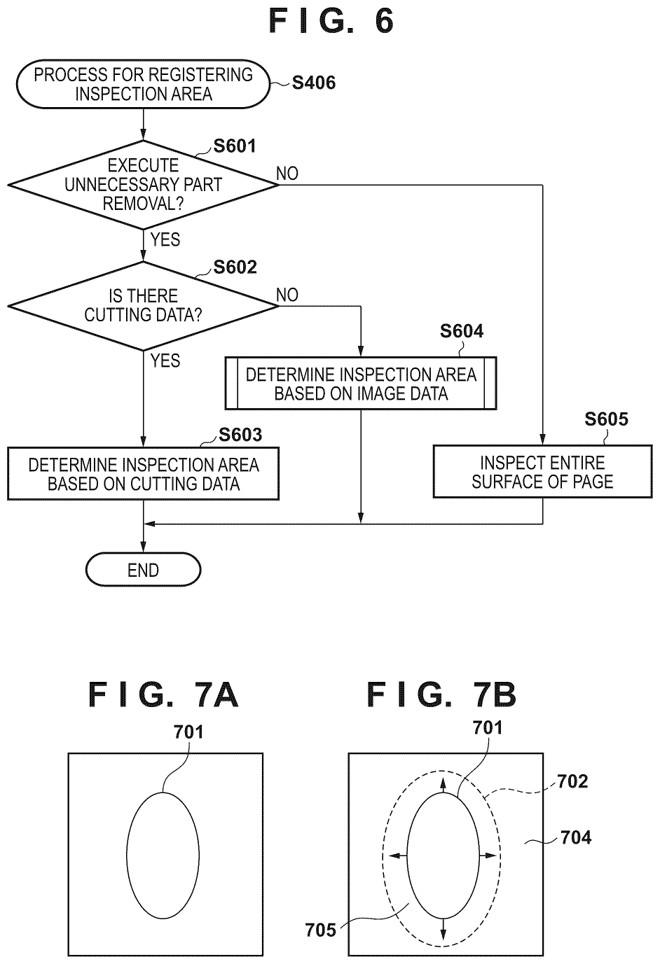

Next, in step S604 of FIG. 6, a process for generating an inspection boundary line from the values of each pixel of the image data will be described with reference to the flowchart of FIG. 8.

FIG. 8 is a flowchart for explaining a process for registering an inspection area based on image data of step S604 of FIG. 6.

First, in step S801, the CPU 223 of the inspection apparatus 200 reads out the image data transferred in step S404 from the storage unit 222. Next, the processing advances to step S802, and the CPU 223 identifies a foreground part in the image data and performs outlining. As the method for identifying the foreground part, there is a method of determining a non-white area of image data as a foreground layer. The foreground layer is image data that is combined with the background layer when the RIP process 130 generates the image data, and is represented by (C, M, Y, K)≠(0, 0, 0, 0), for example. In contrast to this, the background layer is set to, for example, (C, M, Y, K)=(0, 0, 0, 0), which is the original color of the print product.

In the foreground layer, image data of a design is drawn, and since nothing is drawn in the background layer, it is composed of white pixels. In the case of a design where the same white pixels as the background layer are present in the foreground layer, in the RIP process 130, data such as (C, M, Y, K)=(0, 0, 1, 0), for example, is added to the foreground layer. Thus, although the difference cannot be visually discerned, the background layer and the foreground layer can be identified by rewriting non-white pixels to distinguish them from the background layer. However, this does not apply to a case where the background layer is not white and a color is used.

FIG. 7D depicts a view that illustrates an outline 706 of an object that is a foreground layer included in the image data. In FIG. 7D, a part illustrated as a non-white area in the cross hatching is a foreground layer, and the foreground layer is specified by a line of the outline 706.

Next, the processing advances to step S803, and the CPU 223 corrects the outline 706 generated in step S802 to generate an inspection boundary line. The process of step S803 will be described with reference to FIG. 7E.

As in FIG. 7B, the inspection boundary line corresponding to the outline 706 is enlarged to set the inspection boundary line 702. The outside of the inspection boundary line 702 is a non-inspection area 707, and the inside thereof is an inspection area 708. Finally, the image data 703 corresponding to the foreground layer and image data inside of the inspection boundary line 702 are combined to obtain an image of FIG. 7F, and the image is displayed in the display area 518 of FIG. 5D. This concludes detailed description of step S604.

As described above, according to the first embodiment, in a case where the unnecessary part removal is executed in a subsequent stage, it is possible to set only the area that is not discarded in a subsequent step as the inspection target area regardless of the presence or absence of a trim mark and cutting data. This eliminates a useless inspection process including the disposal part and prevents notification of a failure result caused by a defect in the image of the disposal part and discarding of the print product due to the failure result caused by the defect in the image of the disposal part.

### Second Embodiment

The second embodiment describes a case where, in contrast to the inspection in which a RIP image is used as a sample image as described in the first embodiment, a scan inspection in which a read image of a sample print is used as the sample image is applied. In the second embodiment, for example, inspection can be performed even in an environment in which image data transfer between the printing apparatus and the inspection apparatus cannot be performed. Note that description of configurations and processing that are the same as in the first embodiment is omitted as appropriate.

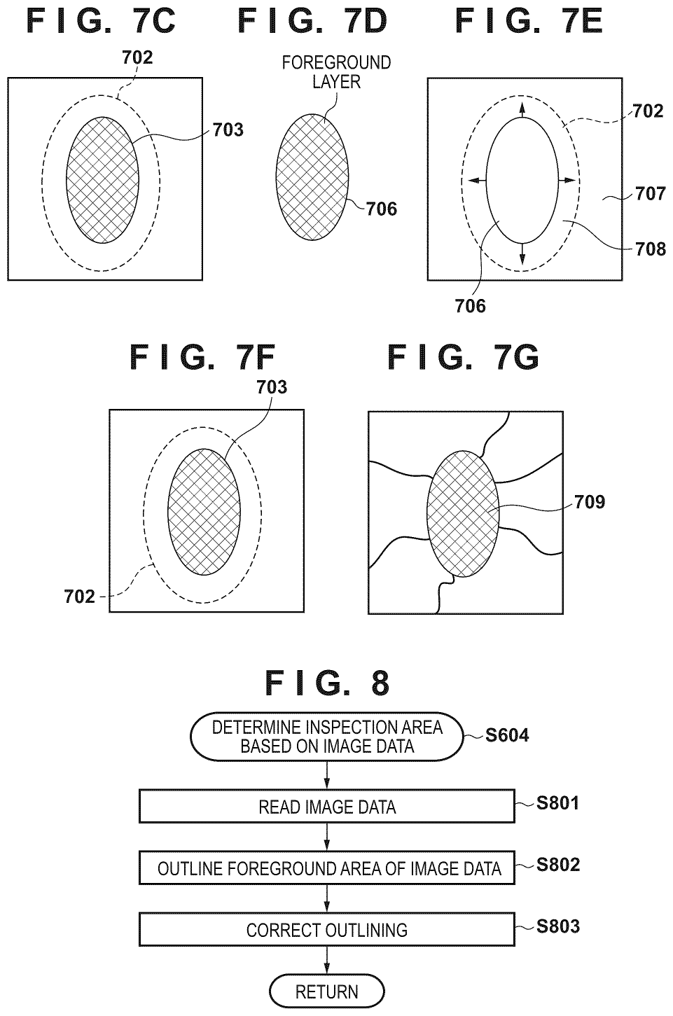

FIG. 9 is a sequence diagram illustrating a flow of processing in the image inspection system according to the second embodiment. Hereinafter, the printing and inspection processing will be described with reference to this sequence diagram. In FIG. 9, the same reference numerals are given to the processes common to those in previously described FIG. 4, and their descriptions are omitted.

A print process of step S901 is basically the same as in step S408 of FIG. 4. However, since the process in step S901 is printing for generating a sample image, one page worth of printing is performed in the feeding direction on the assumption that the printing will be correctly performed. The process for registering the inspection area in step S902 is different from that of step S604 which is internal processing of step S406 of FIG. 4, and the process in step S902 will be described later.

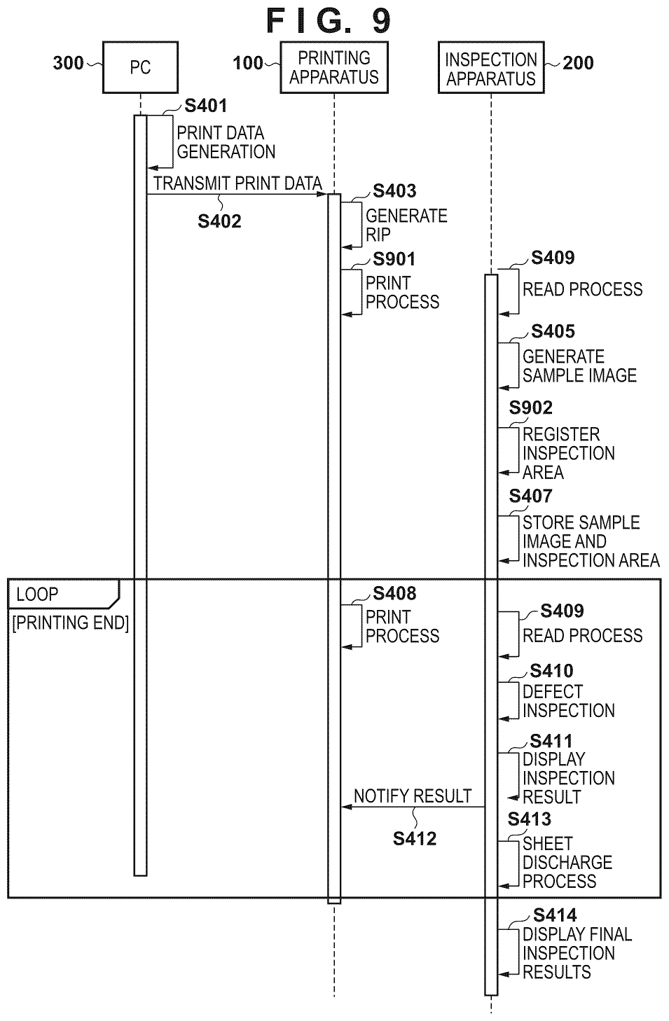

FIG. 10 is a flowchart for explaining a process for registering an inspection area of step S902 of FIG. 9. In FIG. 10, since the processes of step S1001 to step S1003 and step S1005 are the same as the processes of step S601 to step S603, step S605 of FIG. 6, explanation thereof will be omitted.

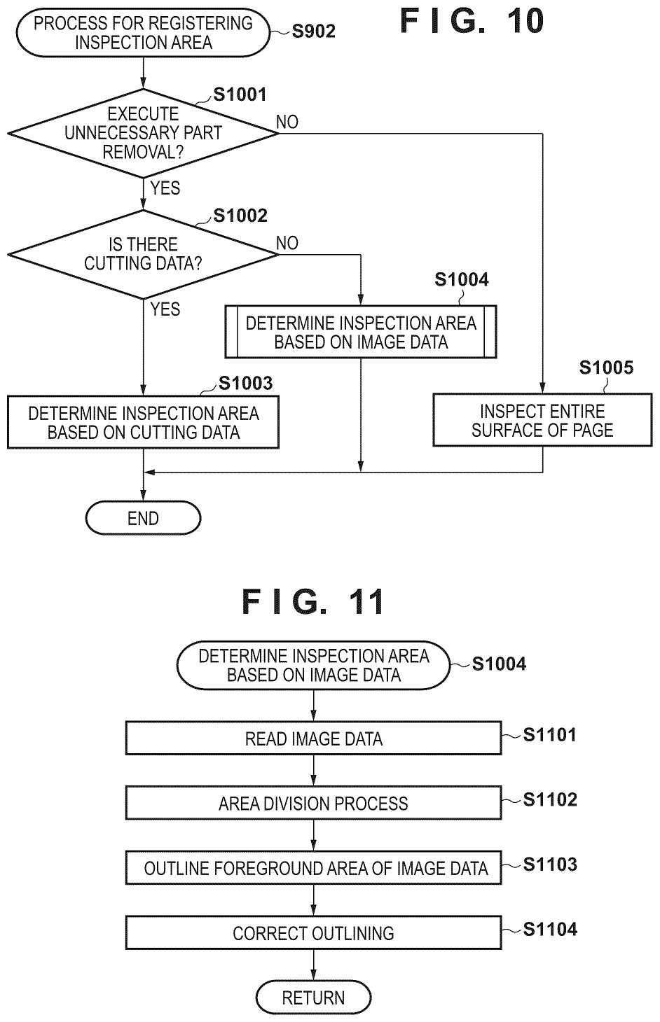

FIG. 11 is a flowchart for explaining a process for determining an inspection area based on image data of step S1004 of FIG. 10.

In step S1101, the CPU 223 of the inspection apparatus 200 reads image data for determining an inspection area. For the image data to be read, a method of using the sample image generated in step S405 can be considered. Alternatively, a method of obtaining the image data generated by the printing apparatus 100 in step S403 and a method of obtaining the image data from a PDF file used in step S401 can also be considered. The image data in this case need not be limited to the printing image, and is not limited in the present embodiment.

Next, the processing proceeds to step S1102 and the CPU 223 performs an area division process on the image data read in step S1101. As the method for area division, for example, there is a segmentation method using a clustering process such as a K-means method. This process integrates classes by similarity and distance between pixels constituting the image data, resulting in large groups called super pixels as illustrated in FIG. 7G.

In FIG. 7G, the sample image is divided into seven groups, and only a group 709 is a group constituting the foreground of the sample image. The other groups are groups that constitute the background and have the same RGB values as the recording medium. In this area division process, since only the foreground needs to be extracted, only the pixel coordinates constituting the group 709 need to be specified.

Next, the processing proceeds to step S1103 and the CPU 223 performs outlining of the group 709 specified in step S1102. In this process, the outermost pixels of the group 709 are concatenated to generate an outline. An outline correction process of step S1104 is the same process as the above-described process of step S803, and therefore will not be described.

It should be noted that the method of determining the inspection area of step S1004 of the second embodiment can be executed as an alternative option to step S604 of the first embodiment. Also, as an alternative option to step S604 of the first embodiment, step S1004 may be executed.

As described above, according to the second embodiment, in an inspection apparatus that reads a print product to obtain a sample image, in a case where unnecessary part removal is executed in a subsequent stage, the area that is not discarded in the subsequent step can be set as the inspection area regardless of the presence or absence of a trim mark and cutting data. As a result, a useless inspection process including the disposal part can be eliminated and notification of a failure result caused by a defect in the image of the disposal part and discarding of the print product can be prevented.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) TM), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-008221, filed Jan. 23, 2024, which is hereby incorporated by reference herein in their entirety.

What is claimed is:

1. An inspection apparatus, comprising:
one or more controllers including one or more processors and one or more memories, the one or more controllers configured to:
read a print product formed by an image forming device to obtain an inspection target image;
obtain a reference image to be used in an inspection of the inspection target image;
determine an inspection area to be targeted in an inspection in the reference image in accordance with whether or not an unnecessary part removal process for removing an unnecessary part of the print product is executed; and
based on the inspection area, perform the inspection by comparing the reference image and the inspection target image,
wherein in determining the inspection area, the one or more controllers determine an area remaining after removing a part corresponding to the unnecessary part from the reference image to be the inspection area in a case of that the unnecessary part removal process is executed.

2. The inspection apparatus according to claim 1, wherein, in obtaining the reference image, the one or more controllers obtain the reference image based on image data used for forming the print product.

3. The inspection apparatus according to claim 2, wherein in determining the inspection area, the one or more controllers determine the inspection area based on cutting information referenced in the unnecessary part removal process.

4. The inspection apparatus according to claim 3, wherein in determining the inspection area, the one or more controllers set an approximate center of an area that the cutting information indicates as a reference, and determine the inspection area based on an enlarged area that enlarges the area by a predetermined amount.

5. The inspection apparatus according to claim 3, wherein the cutting information is included in the image data used to form the print product.

6. The inspection apparatus according to claim 1, wherein, in obtaining the reference image, the one or more controllers obtain, as the reference image, image data obtained by reading the print product.

7. The inspection apparatus according to claim 1, wherein the one or more controllers determine whether or not the unnecessary part removal process is executed in accordance with whether or not a cutting device is connected to the inspection apparatus.

8. The inspection apparatus according to claim 2, wherein in determining the inspection area, the one or more controllers determine the inspection area based on image data corresponding to a foreground layer in which image data of a design is drawn, the foreground layer being included in the reference image.

9. The inspection apparatus according to claim 2, wherein in determining the inspection area, the one or more controllers execute an area division process on the reference image, and among a plurality of areas obtained in the area division process, determine the inspection area based on an area including a foreground layer in which image data of a design is drawn.

10. The inspection apparatus according to claim 9, wherein in determining the inspection area, the one or more controllers determine the inspection area by executing the area division process in a case where cutting information referenced in the unnecessary part removal process has not been received.

11. The inspection apparatus according to claim 8, wherein the foreground layer is represented by (C, M, Y, K)≠(0, 0, 0, 0) in a case where the print product is white.

12. The inspection apparatus according to claim 1, wherein in determining the inspection area, the one or more controllers determine the entirety of the reference image to be the inspection area in a case that the unnecessary part removal process is not executed.

13. An inspection system, comprising: an inspection apparatus comprising one or more controllers including one or more processors and one or more memories, the one or more controllers configured to:
read a print product formed by an image forming device to obtain an inspection target image;
obtain a reference image to be used in an inspection of the inspection target image;
determine an inspection area to be targeted in an inspection in the reference image in accordance with whether or not an unnecessary part removal process for removing an unnecessary part of the print product is executed; and
based on the inspection area, perform the inspection by comparing the reference image and the inspection target image,
wherein in determining the inspection area, the one or more controllers determine an area remaining after removing a part corresponding to the unnecessary part from the reference image to be the inspection area in a case of the unnecessary part removal process is executed, and
an image forming device generates a print product in which an image is printed on a recording medium,
wherein the inspection apparatus inspects the print product generated by the image forming device.

14. A method for controlling an inspection apparatus, the method comprising:
reading a print product formed by an image forming device to obtain an inspection target image;
obtaining a reference image to be used in an inspection of the inspection target image;
determining an inspection area to be targeted in an inspection in the reference image in accordance with whether or not an unnecessary part removal process for removing an unnecessary part of the print product is executed; and
based on the determined inspection area, performing the inspection by comparing the reference image and the inspection target image,
wherein in determining the inspection area, the one or more controllers determine an area remaining after removing a part corresponding to the unnecessary part from the reference image to be the inspection area in a case that the unnecessary part removal process is executed.
